(19) United States
(12) Patent Application Publication
(10) Pub. No.: US 2015/0253536 A1
(43) Pub. Date: Sep. 10, 2015

(54) AUTONOMOUS VEHICLE WITH ADAPTIVE SIDE VIEW MIRRORS

(71) Applicant: Ford Global Technologies, LLC, Dearborn, MI (US)

(72) Inventors: Jialiang Le, Canton, MI (US); Thomas Edward Pilutti, Ann Arbor, MI (US); Manoharprasad K. Rao, Novi, MI (US); Matthew Y. Rupp, Canton, MI (US); Roger Arnold Trombley, Ann Arbor, MI (US); Andrew Waldis, Orion Township, MI (US)

(73) Assignee: Ford Global Technologies, LLC, Dearborn, MI (US)

(21) Appl. No.: 14/202,959

(22) Filed: Mar. 10, 2014

(51) Int. Cl. G02B 7/182; B60R 1/00

(52) U.S. Cl. CPC G02B 7/182; B60R 1/006

(57) ABSTRACT

A vehicle includes at least one side view mirror assembly configured to move to a folded position. A processing device is configured to command the at least one side view mirror assembly to move to the folded position when the vehicle is operating in an autonomous mode. A method includes determining whether a vehicle is operating in an autonomous mode and commanding at least one side view mirror assembly to move to a folded position if the vehicle is operating in the autonomous mode.

### BACKGROUND

Autonomous vehicles are becoming more sophisticated. As the level of sophistication increases, the amount of passenger interaction required by the autonomous vehicle decreases. Eventually, autonomous vehicles may require no passenger interaction beyond, e.g., selecting a destination, leaving passengers to focus on non-driving-related tasks. Since autonomous vehicles assume certain driving responsibilities, certain vehicle components are not always needed. Such components, however, must remain part of the vehicle for instances where the vehicle is operating in a non-autonomous mode.

### BRIEF DESCRIPTION OF THE DRAWINGS

FIG. 1 illustrates an exemplary autonomous vehicle having adaptive side view mirrors.

FIG. 2 is a block diagram of an exemplary system used in the vehicle of FIG. 1.

FIG. 3 illustrates an exemplary motorized side view mirror.

FIG. 4 is a flowchart of an exemplary process that may be used to control the position of the side view mirrors.

### DETAILED DESCRIPTION

An exemplary vehicle includes at least one side view mirror assembly configured to move to a folded position. A processing device is configured to command the at least one side view mirror assembly to move to the folded position when the vehicle is operating in an autonomous mode. An exemplary method includes determining whether the vehicle is operating in the autonomous mode, and if so, commanding at least one side view mirror assembly to move to the folded position. The system, therefore, may automatically move the vehicle side view mirrors to a folded position closer to the vehicle when the vehicle is being operated in the autonomous mode and automatically move the side view mirrors to normal expanded field of view position when the vehicle is being operated in a non-autonomous mode.

The elements shown in the FIGS. may take many different forms and include multiple and/or alternate components and facilities. The exemplary components illustrated are not intended to be limiting. Indeed, additional or alternative components and/or implementations may be used.

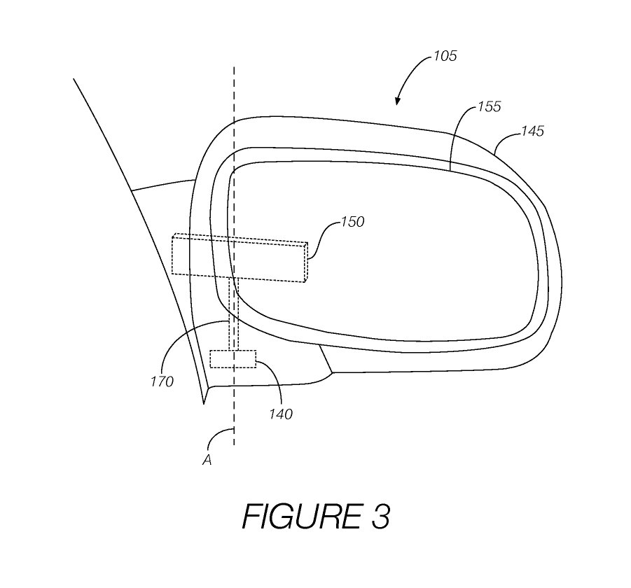

As illustrated in FIG. 1, the vehicle 100 includes at least two side view mirror assemblies 105 (although only one is visible in FIG. 1) and a steering wheel 110 located in a passenger compartment 115 of the vehicle 100. The side view mirror assemblies 105 may include mirrors 155 (see FIG. 3) that allow a user to see an area next to and/or behind the vehicle 100. The steering wheel 110 may be configured to allow the user to control the direction of the vehicle 100 when the vehicle 100 is operating in a non-autonomous mode. The vehicle 100 may be further configured to operate in an autonomous (i.e., driverless) mode, which may include one or more partially autonomous modes. When operating in the autonomous mode, the vehicle 100 assumes at least some driving-related tasks such as controlling the speed and/or direction of the vehicle 100. Thus, the side view mirror assemblies 105 may be configured to move to a folded position (i.e., with the mirrors 155 facing the vehicle 100) when the vehicle 100 is operating in the autonomous mode and an unfolded position when the vehicle 100 is operating in the non-autonomous mode. Although illustrated as a sedan, the vehicle 100 may include any passenger or commercial vehicle such as a car, a truck, a sport utility vehicle, a taxi, a bus, etc.

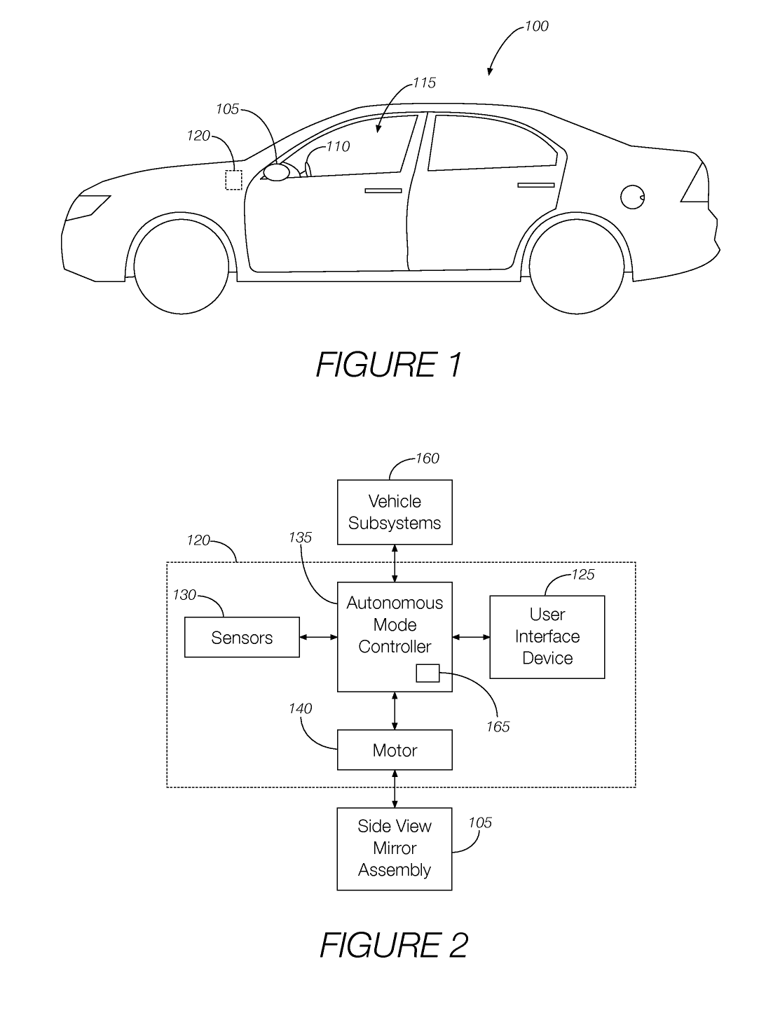

Referring now to FIG. 2, the vehicle 100 may incorporate a system 120 for controlling the autonomous operation of the vehicle 100. The system 120 may further control the position of the side view mirror assembly 105 during autonomous and non-autonomous operation of the vehicle 100. The system 120, as illustrated in FIG. 2, includes a user interface device 125, at least one sensor 130, an autonomous mode controller 135, and a motor 140.

The user interface device 125 may be configured to present information to a user, such as a driver, during operation of the vehicle 100. Moreover, the user interface device 125 may be configured to receive user inputs. Thus, the user interface device 125 may be located in the passenger compartment 115 of the vehicle 100. In some possible approaches, the user interface device 125 may include a touch-sensitive display screen. Alternatively, the user interface device 125 may include or be incorporated into the steering wheel 110. In other words, the steering wheel 110 may be configured to receive user inputs indicating, e.g., the user's desire to assume control over the vehicle 100 when the vehicle 100 is operating in the autonomous mode.

The sensors 130 may include any number of devices configured to generate signals that help navigate the vehicle 100 while the vehicle 100 is operating in an autonomous (e.g., driverless) mode. Examples of sensors 130 may include a radar sensor, a lidar sensor, a vision sensor, or the like. The sensors 130 help the vehicle 100 “see” the roadway and the vehicle 100 surroundings and/or negotiate various obstacles while the vehicle 100 is operating in the autonomous mode. Some sensors 130 may be configured to measure various factors related to the fuel efficiency of the vehicle 100. Such factors may include wind resistance and the speed of the vehicle 100.

The autonomous mode controller 135 may be configured to control one or more subsystems 160 while the vehicle 100 is operating in the autonomous mode. Examples of subsystems 160 that may be controlled by the autonomous mode controller 135 may include a brake subsystem, a suspension subsystem, a steering subsystem, and a powertrain subsystem. The autonomous mode controller 135 may control any one or more of these subsystems 160 by outputting signals to control units associated with these subsystems 160. The autonomous mode controller 135 may control the subsystems 160 based, at least in part, on signals generated by the sensors 130.

The autonomous mode controller 135 may, in some possible approaches, incorporate a processing device 165 configured to receive, process, and output various signals. For instance, the processing device 165 may be configured to output signals commanding the side view mirror assemblies 105 to move to a folded and/or unfolded position based on whether the vehicle 100 is operating in the autonomous or non-autonomous mode. In some instances, the processing device 165 may command the side view mirror assemblies 105 to change positions based upon a user input. One user input may command the vehicle 100 to operate in the autonomous mode, which may cause the processing device 165 to command the side view mirror assemblies 105 to move to the folded position. Another user input may command the vehicle 100 to operate in the non-autonomous mode, which may cause the processing device 165 to command the side view mirror assemblies 105 to move to the unfolded position. The user input may be provided via the user interface device 125, which as discussed above, may include a touch-sensitive display screen. Alternatively or in addition, the steering wheel 110 may act as the user interface device 125, in which case the user may provide the user input through a motion such as turning the steering wheel 110, e.g., as if the user had control over the vehicle 100.

The processing device 165 moving the side view mirrors 105 to the folded position when operating in the autonomous mode may have beneficial effects such as increasing the vehicle fuel economy due to reduced wind resistance at higher speeds of the vehicle 100. It may also reduce the possibility of side view mirrors 105 hitting nearby objects when traveling in narrow spaces by reducing the width of the vehicle 100. In some alternate approaches the processing device 165 may further determine whether to move the side view mirror assemblies 105 to the folded position based on one or more factors concerning fuel economy such as vehicle speed. For instance, the processing device 165 may receive signals, generated by one or more of the sensors 130, relating to fuel economy factors such as the vehicle speed and wind resistance. The processing device 165 may determine whether to move the side view mirror assemblies 105 to the folded position based on the fuel economy factors since folding in the side view mirrors 155 may decrease the wind resistance of the vehicle 100, resulting in an increase in fuel economy.

The motor 140 may be configured to move the side view mirror assembly 105 from, e.g., the folded position to the unfolded position, and vice versa. The motor 140 may be configured to move the side view mirror assembly 105 in response to a command signal received from, e.g., the processing device 165. In one possible implementation, the motor 140 may include a stepper motor.

In general, computing systems and/or devices, such as the user interface device 125, the autonomous mode controller 135, and the processing device 165, may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, New York, the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, an on-board vehicle 100 computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

FIG. 3 illustrates an exemplary side view mirror assembly 105 that has a housing 145, a motor 140, a bracket 150, and a mirror 155. The motor 140 and the bracket 150 may be disposed between the housing 145 and the mirror 155. Thus, the motor 140 and bracket 150 may not be visible during operation of the vehicle 100. The bracket 150 may be configured to attach the motor 140 to the housing 145, the mirror 155, or both. The side view mirror assembly 105 may further include a pivot 170 that defines an axis A about which at least a portion of the housing 145 rotates. In some possible approaches, the motor 140, the bracket 150, the mirror 155, and at least a portion of the housing 145 fold in and fold out together.

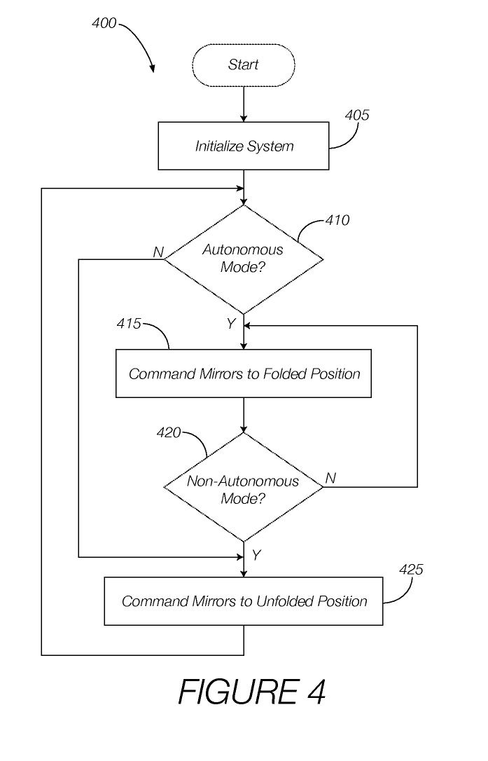

FIG. 4 is a flowchart of an exemplary process 400 that may be executed by one or more components of the vehicle 100, and specifically, the system 120 illustrated in FIG. 2.

At block 405, the processing device 165 may initialize the system 120. Initializing the system 120 may include confirming that, e.g., the vehicle 100 is turned on, the vehicle 100 is operating in a non-autonomous mode of operation, and in some instances, the side view mirror assemblies 105 are in the unfolded position. If the side view mirror assemblies 105 are not in the unfolded position, the processing device 165 may command the side view mirror assemblies 105 to move to the unfolded position as part of the initialization.

At decision block 410, the processing device 165 may determine whether the vehicle 100 is operating in the autonomous mode. The processing device 165 may make such a determination based upon, e.g., a user input commanding the vehicle 100 to operate in the autonomous mode. If the vehicle 100 is operating in the autonomous mode, the process 400 may continue at block 415. If the vehicle 100 is operating in a non-autonomous mode, or a partially autonomous mode that requires the driver to use the side view mirror assemblies 105, the process 400 may continue at block 425. If the side view mirror assemblies 105 are already in the unfolded position as, e.g., a result of the initialization at block 405, the process 400 may return to block 410 until the vehicle 100 enters the autonomous mode or the vehicle 100 is turned off

At block 415, the processing device 165 may command the side view mirror assemblies 105 to move to the folded position. Commanding the side view mirror assemblies 105 to move to the folded position may include outputting a command signal to the motor 140 associated with each side view mirror assembly 105. The motor 140 may push the housing 145 and the mirror 155 toward the vehicle 100 to move the side view mirror assembly 105 to the folded position.

At decision block 420, the processing device 165 may determine whether the vehicle 100 is operating in a non-autonomous mode or a partially autonomous mode that requires use of the side view mirror assembly 105. If so, the process 400 may continue at block 425. If the mode has not changed (e.g., the vehicle 100 is still operating in the autonomous mode), the process 400 may continue at block 415 or, in some instances, instead of commanding the mirrors to move to the folded position, the processing device 165 may command the side view mirror assemblies 105 to remain in their present (e.g., folded) position.

At block 425, the processing device 165 may command the side view mirror assemblies 105 to move to the unfolded position. Commanding the side view mirror assemblies 105 to move to the unfolded position may include outputting a command signal to the motors 140 associated with each side view mirror assembly 105. The motor 140 may push the housing 145 and the mirror 155 away from the vehicle 100 to move the side view mirror assembly 105 to the unfolded position.

After block 425, the process 400 may return to decision block 410. The process 400 may end when the vehicle 100 is turned off or upon receipt of a user input commanding the system 120 to turn off.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle comprising:
at least one side view mirror assembly configured to move to a folded position; and
a processing device configured to command the at least one side view mirror assembly to move to the folded position when the vehicle is operating in an autonomous mode.

2. The vehicle of claim 1, further comprising a motor configured to move the at least one side view mirror assembly from an unfolded position to the folded position.

3. The vehicle of claim 2, wherein the motor is configured to move the at least one side view mirror assembly from the folded position to the unfolded position.

4. The vehicle of claim 2, wherein the motor is configured to move the at least one side view mirror assembly in response to a command generated by the processing device.

5. The vehicle of claim 1, wherein the processing device is configured to determine whether the vehicle is operating in an autonomous mode.

6. The vehicle of claim 1, wherein the processing device is configured to command the at least one side view mirror assembly to move to an unfolded position prior to the vehicle operating in a non-autonomous mode.

7. The vehicle of claim 1, wherein the processing device is configured to command the at least one side view mirror assembly to move to at least one of a folded position and an unfolded position in response to a user input.

8. The vehicle of claim 1, further comprising:
at least one sensor; and
an autonomous mode controller configured to control at least one vehicle subsystem based at least in part on signals generated by the sensor.

9. The vehicle of claim 8, wherein the processing device is integrated into the autonomous mode controller.

10. A method comprising:
determining whether a vehicle is operating in an autonomous mode;
commanding at least one side view mirror assembly to move to a folded position if the vehicle is operating in the autonomous mode.

11. The method of claim 10, further comprising determining whether the vehicle is operating in a non-autonomous mode.

12. The method of claim 10, further comprising commanding the at least one side view mirror assembly to move to an unfolded position prior to the vehicle operating in the non-autonomous mode.

13. The method of claim 10, further comprising:
receiving a user input; and
commanding the at least one side view mirror assembly to move to at least one of the folded position and an unfolded position in response to the user input.

14. A vehicle system comprising:
at least one sensor;
an autonomous mode controller configured to control at least one vehicle subsystem based at least in part on signals generated by the sensor when operating in an autonomous mode;
wherein the autonomous mode controller includes a processing device configured to command the at least one side view mirror assembly to move to a folded position when operating in the autonomous mode.

15. The vehicle system of claim 14, further comprising a motor configured to move the at least one side view mirror assembly from an unfolded position to the folded position.

16. The vehicle system of claim 14, wherein the motor is configured to move the at least one side view mirror assembly from the folded position to the unfolded position.

17. The vehicle system of claim 14, wherein the motor is configured to move the at least one side view mirror assembly in response to a command generated by the processing device.

18. The vehicle system of claim 14, wherein the processing device is configured to determine whether the autonomous mode controller is operating in the autonomous mode.

19. The vehicle system of claim 14, wherein the processing device is configured to command the at least one side view mirror assembly to move to an unfolded position prior to the autonomous mode controller operating in a non-autonomous mode.

20. The vehicle system of claim 14, wherein the processing device is configured to command the at least one side view mirror assembly to move to at least one of a folded position and an unfolded position in response to a user input.
